(19) United States
(12) Patent Application Publication
(10) Pub. No.: US 2009/0060679 A1
(43) Pub. Date: Mar. 5, 2009

(54) Fastening apparatus of a heat radiator

(76) Inventor: Chin-Hsing Horng, Taoyuan (TW)

Correspondence Address: Meng-Tsuey Pan, P. O. Box 1-252, Sanchung, TW

(21) Appl. No.: 11/897,279

(22) Filed: Aug. 31, 2007

(51) Int. Cl. F16B 5/07

(52) U.S. Cl. 411/508

(57) ABSTRACT

A fastening apparatus of a heat radiator, disposed on an upper folding edge and a lower folding edge of each radiator body, comprises more than one opening on each of the folding edges, more than one arrow-headed fastener with a notch in the center thereof, and more than one inwardly slanted projection on each upper and lower folding edges respectively. The arrow-headed fasteners on the upper and lower folding edges of each previous radiator body sequentially hook to the corresponding openings on the upper and lower folding edges of each next radiator body, so that a plurality of heat radiators are joined integrally, the inwardly slanted projections are disposed on the upper and lower folding edges of each previous radiator body to hold the rear part of each next radiator body, and the fastening apparatuses are joined more stably at a constant distance, and thus are prevented from being loosened.

### BACKGROUND OF THE INVENTION

1. Field of the Invention

The present invention relates to a fastening apparatus of a heat radiator having a simple structure, which may be installed easily, joined together integrally and firmly, and may prevent the heat-dissipating wind (airflow) from escaping out of the upper and lower sides of the heat radiator.

2. Description of the Related Art

The conventional fastening apparatus of a heat radiator (also known as a coupling structure or a connector) as revealed in previous disclosures includes Taiwan Patents No. 468931, 524343, 484704, 558009, as well as U.S. Pat. Nos. 6,499,160B1, 6,382,307B1 and 6,619,381B1; one unit or more than one pair of hooks, hook sections or fastening components are extendedly disposed on an upper folding edge or a lower folding edge of each heat radiator, and openings are disposed on the upper folding edge, on the lower folding edge, or on the radiator body of the heat radiator corresponding to the hooks, hook sections or fastening components. The disclosed fastening apparatus may allow a previous radiator body to be coupled to a next radiator body sequentially, via the method of connecting hooks (or hook sections or fastening components) extendedly disposed on the upper folding edge and the lower folding edge of the previous radiator body to the openings correspondingly disposed on the upper folding edge and the lower folding edge of the next radiator body, so that a plurality of heat radiators may be joined together integrally. However, there is no auxiliary holding (supporting) apparatus on the upper and lower folding edges. When the heat radiators are joined together, only the hooks (or hook sections or fastening components) on the upper and lower folding edges are installed with the openings. Thus, the heat radiators are easily loosened or separated, resulting in difficulty in transportation or assembly process, which is the worst shortcoming of the conventional fastening apparatus of a heat radiator. Moreover, excessively large hollows (or holes) are disposed between the openings and the hooks (or hook sections or fastening components) on the upper and lower folding edges or on the radiator bodies in some conventional fastening apparatuses of heat radiators, resulting in that the heat-dissipating wind (airflow) by a fan escapes from the hollows (or holes); consequently, the heat-dissipating wind (airflow) radiates badly or less effectively, which is the second shortcoming.

In the conventional fastening apparatus of a heat radiator, the openings and the hooks (or hook sections or fastening components) often come with infirm connection that leads to some problems like the heat radiators cannot be firmly joined together and the heat radiators are easily loosened or separated, or the heat-dissipating wind (airflow) radiates less ineffectively. Thus, the inventor of the invention conducted research, which culminated in the fastening apparatus of a heat radiator of the present invention.

### SUMMARY OF THE INVENTION

The objective of the invention is to provide a fastening apparatus of a heat radiator having a simple structure, which may be installed easily, joined together integrally and firmly, and may prevent the heat-dissipating wind (airflow) from escaping out of the upper and lower sides of the heat radiator.

To achieve the objective of the present invention, a fastening apparatus of a heat radiator is disposed on an upper folding edge and a lower folding edge of each radiator body, comprising at least one opening or more disposed on each of the upper and lower folding edges, at least one arrow-headed fastener or more with a notch in the center thereof, extendedly disposed on the front edges of the upper and lower folding edges corresponding to each opening, and more than one inwardly slanted projection disposed on each upper and lower folding edges. The arrow-headed fasteners on the upper and lower folding edges of a previous radiator body sequentially hook to the openings on the corresponding positions of a next radiator body and almost cover the openings. The inwardly slanted projection disposed on the upper and lower folding edges of each previous radiator body holds (supports) the rear part of each next radiator body in an auxiliary manner. Thus, a plurality of heat radiators may be joined integrally and firmly, the escaping of the heat-dissipating wind (airflow) by a fan from the upper and lower fastening apparatuses can be prevented, and the fastening apparatuses can be prevented from being loosened or separated.

### BRIEF DESCRIPTION OF THE DRAWINGS

FIG. 1 is an isometric view of a heat radiator according to one preferred embodiment of the present invention.

FIG. 2 is an enlarged view of the A section in FIG. 1.

FIG. 3 is an enlarged view of the B section in FIG. 1.

FIG. 4 is an isometric view showing two heat radiators ready to be hooked together.

FIG. 5 is an isometric view showing a plurality of heat radiators being assembled in parallel.

### DETAILED DESCRIPTION OF THE PREFERRED EMBODIMENT

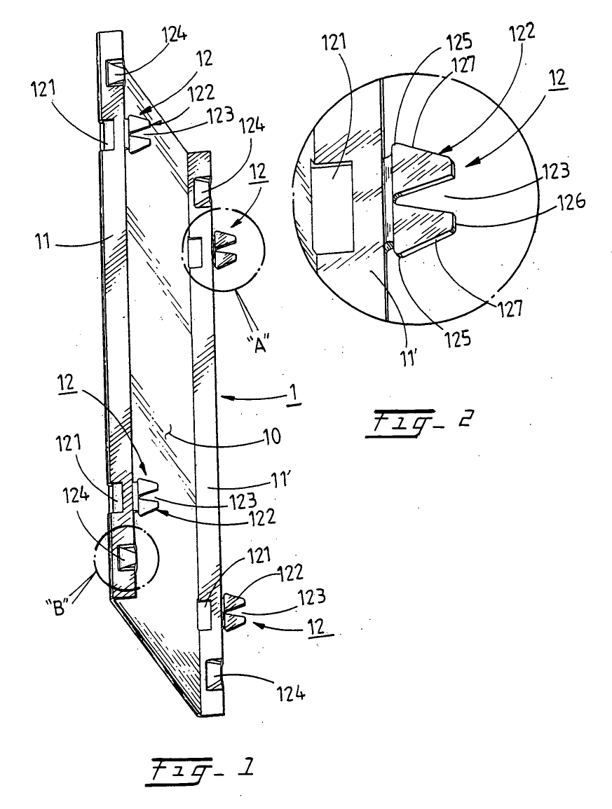

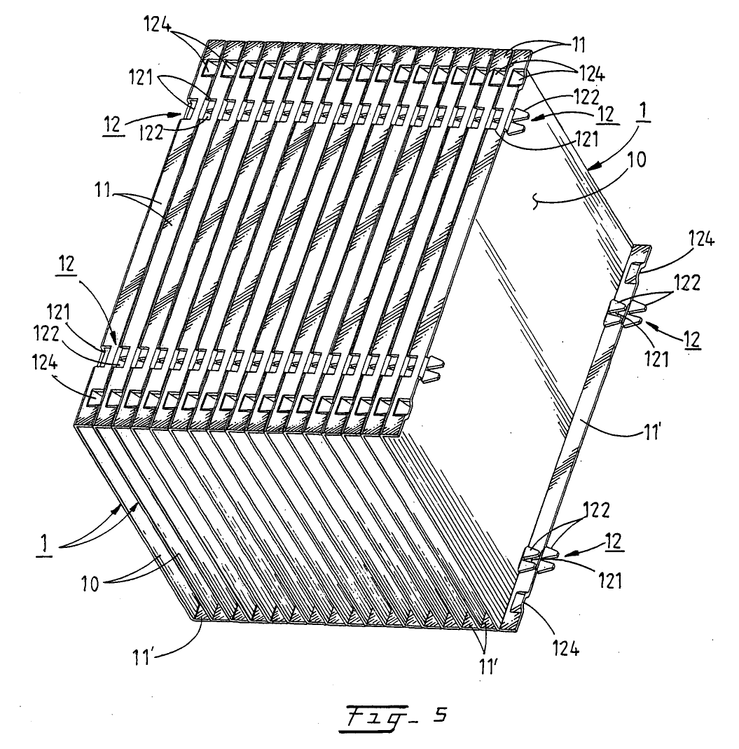

Referring to FIG. 1, each radiator body 10 of a heat radiator 1 according to one preferred embodiment of the invention has a basic structure identical to that of a conventional radiator body of a heat radiator. The radiator body 10 has an upper folding edge 11 and a lower folding edge 11′ separately formed on an upper side and a lower side thereof, and more than one fastening apparatus 12 is disposed on the upper folding edge 11 and the lower folding edge 11′. The fastening apparatus 12 mainly comprises at least more than one opening 121 disposed on each of the upper and lower folding edges 11 and 11′, at least more than one arrow-headed fastener 122 with a notch 123 in the center thereof, extendedly disposed on the front edges of the upper and lower folding edges 11 and 11′ corresponding to each opening 121, and more than one inwardly slanted projection 124 disposed on each upper and lower folding edges 11 and 11′. The arrow-headed fasteners 122 hook to each corresponding opening 121 on the upper and lower folding edges 11 and 11′ of each adjacent radiator body 10 (as shown in FIG. 4) and almost cover the openings 121. The inwardly slanted projection 124 disposed on the upper and lower folding edges 11 and 11′ of each previous radiator body 10 holds (supports) the rear part of each next radiator body 10 in an auxiliary manner, so that every two radiator bodies 10 are joined integrally, securely and at a constant distance, thereby preventing from being loosened or separated.

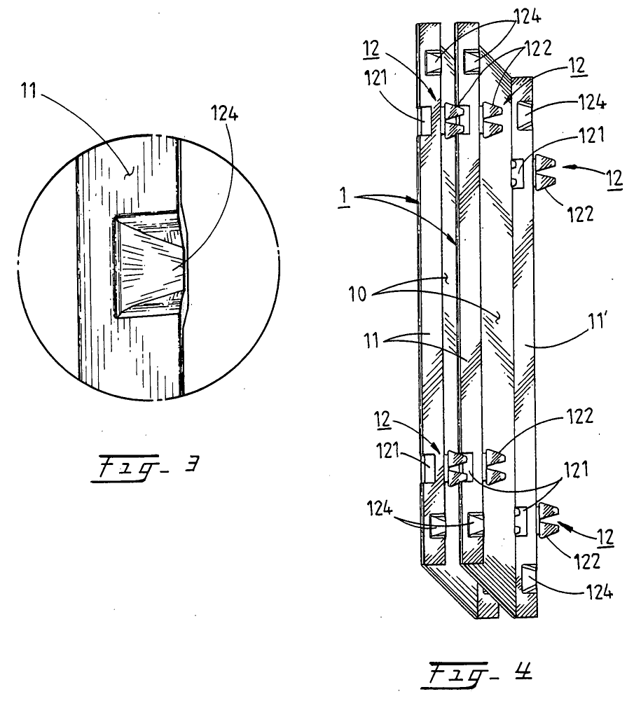

When a plurality of heat radiators 1 are joined together to form a set of heat radiators as shown in FIG. 4, the arrow-headed fasteners 122 of each fastening apparatus 12 on the upper and lower sides of a previous radiator body 10 are respectively inserted into the openings 121 on the upper and lower folding edges 11 and 11′ of a next radiator body 10, and then the two radiator bodies 10 are joined integrally and stably. Therefore, the next and the further radiator bodies 10 are continuously joined in sequence, and then a row of radiator bodies 10 (as shown in FIG. 5) are assembled in order to become a heat sink (not shown in the figures), and the row of radiator bodies 10 are soldered by means of copper or silver onto a plate. Because the inwardly slanted projection 124 is disposed on the upper and lower folding edges 11 and 11′ of the radiator body 10 of each heat radiator 1, every two radiator bodies 10 are joined together integrally by lock edges 125 (as shown in FIG. 2) on two sides of the arrow-headed fastener 122 of each fastening apparatus 12; the lock edges 125 are wedged onto the two sides of the opening 121 of the radiator bodies 10, and by each inwardly slanted projection 124 on the upper and lower folding edges 11 and 11′ of each previous radiator body 10 to hold (support) the rear part of each next radiator body 10, so that the two radiator bodies 10 are joined firmly and at a constant distance, thereby preventing from being loosened or separated. When the radiators are joined together integrally, each arrow-headed fastener 122 almost covers each opening 121, which may prevent the heat-dissipating wind (airflow) from escaping out of the upper and lower fastening apparatuses.

Please refer to FIG. 2 again. This is an enlarged view of each fastening apparatus 12 according to one preferred embodiment of the present invention. The shape of the opening 121 on the upper and lower folding edges 11 and 11′ in general preferred embodiments can be rectangular as illustrated in the figure, arc-shaped, semicircular, or other geometric shapes. The shape of the notch 123 in the center of the arrow-headed fastener 122 of each fastening apparatus 12 is V-shaped, U-shaped or other similar shape. Similarly, the inwardly slanted projection 124 on each upper and lower folding edge 11 and 11′ can be in the form of a square bracket as indicated in FIG. 3, a triangle, a flat square U-shape or an arc, as long as the openings 121, notches 123 and inwardly slanted projections 124 match with each other properly which allows each fastening apparatus 12 to be joined together stably.

As shown in FIG. 2, although the width of the arrow-headed fastener 122 of each fastening apparatus 12 between two lock edges 125 is much larger than the width of the opening 121, the width of a front end 126 thereof is much smaller than the width of the opening 121. Therefore, the front end 126 of the arrow-headed fastener 122 can be easily and smoothly inserted into the opening 121. Besides, the notch 123 is disposed in the middle of the arrow-headed fastener 122, so the two sides of the front end 126 become close to the center naturally when the arrow-headed fastener 122 is inserted into the opening 121 and two outer edges 127 come into contact with the inner edges at two sides of the opening 121, resulting in the shrinking status of the two lock edges 125 and the smooth insertion into the opening 121. After being inserted into the opening 121, the two lock edges 125 spring open by the material stress of the arrow-headed fastener 122, so as to be wedged onto the two sides of the opening 121 on the radiator body 10 of the heat radiator 1.

Although a preferred embodiment of the invention has been described for purposes of illustration, it is understood that various changes and modifications to the described embodiment can be carried out without departing from the scope and the spirit of the invention as disclosed in the appended claims.

What is claimed is:

1. A fastening apparatus of a heat radiator being disposed on an upper folding edge and a lower folding edge of one radiator body, comprising:
at least one opening or more disposed on each of the upper folding edge and the lower folding edge;
at least one arrow-headed fastener or more with a notch in the center thereof, extendedly disposed on front edges of the upper folding edge and the lower folding edge corresponding to each opening; and
more than one inwardly slanted projection disposed on the upper folding edge and the lower folding edge respectively, wherein the arrow-headed fasteners on the upper folding edge and the lower folding edge of each previous radiator body sequentially hook to the openings on the corresponding positions of the upper folding edge and the lower folding edge of each next radiator body and almost cover the openings, so that a plurality of heat radiators are joined together integrally, the inwardly slanted projections are disposed on the upper folding edge and the lower folding edge of each previous radiator body to hold the rear part of each next radiator body, and fastening apparatuses are joined more stably and firmly at a constant distance, and are prevented from being loosened or separated.

2. The fastening apparatus of a heat radiator of claim 1, wherein the opening may be in the shape of a rectangle, an arc, a semicircle or other geometric shapes, the notch on the arrow-headed fastener may be V-shaped, U-shaped or other similar shapes, and the shape of the inwardly slanted projection may be in the form of a square bracket, a triangle, a flat square U-shape or an arc.
